(19) United States
(12) Patent Application Publication
(10) Pub. No.: US 2009/0127268 A1
(43) Pub. Date: May 21, 2009

(54) ANODISED CULINARY ITEM AND METHOD FOR PRODUCING ONE SUCH ITEM

(75) Inventors: Pascal Cuillery, Faverges (FR); Jean-Francois Brasset, Annecy (FR)

Correspondence Address: WINSTON & STRAWN LLP;PATENT DEPARTMENT, 1700 K STREET, N.W., WASHINGTON, DC, 20006, US

(73) Assignee: SEB SA a company

(21) Appl. No.: 12/279,296

(22) PCT Filed: Feb. 14, 2007
(86) PCT No.: PCT/FR2007/000267

§ 371 Date: Nov. 24, 2008

(30) Foreign Application Priority Data
Feb. 14, 2006 (FR) 0601313

(51) Int. Cl. A47J 27/00; C23C 28/04

(52) U.S. Cl. 220/573.1; 205/188

(57) ABSTRACT

The invention relates to a culinary item formed from a swaged aluminum or aluminum alloy sheet having the end form of the item and comprising a bottom and a lateral wall, the outer surface of the bottom comprising a plate which is centered on the bottom and covers at least part of the sheet. The plate is formed from a metal or a material coated with a metal, a carbide or a metal nitride, said metal being selected in such a way as to resist an anodizing step. The outer surface at least of the lateral wall consists of a anodized aluminum or anodized aluminum alloy, and the inner surface of the culinary item is provided with a first anti-adhesive coating. The invention also relates to a method for producing one such item.

The present invention relates to a culinary item formed from an anodised aluminium or anodised aluminium alloy sheet, said sheet being deformed to form a hollow container able to receive food. The present invention also relates to a method for producing one such item.

Among the culinary items that are currently commercially available, the anodised aluminium or anodised aluminium alloy items form a product series highly valued for aesthetics thereof.

In the following of the present description, the term “anodised aluminium” will be used for both anodised aluminium as such and an anodised aluminium alloy, that is an aluminium alloy sheet that will have been subjected to a treatment intended to form an anodising layer.

Conventionally, these culinary items have an inner surface that is intended to receive food, in particular for baking. This inner surface includes, very commonly, an anti-adhesive coating, for example an enamel layer or, preferably, a coating based on one or more fluorocarboned resins.

As for the outer surface of these culinary items, it is made of anodised aluminium, or anodised aluminium alloy. The anodising layer provides to these items an similar appearance to that of slate, visually soft to the touch. This outer surface has thus an appearance less cold than a smooth aluminium or aluminium alloy surface.

Besides this aesthetical aspect, producing such an anodising layer enables these culinary items to be particularly shock resistant and easy to wash.

However, after a number of repeated cooling and heating cycles, the bottom of such culinary items appears to be bulged. Because of this irreversible warping, such culinary items become unusable, at least on heat sources such as solid plates or ceramic hobs.

This phenomenon is observable even if the bottom of the culinary items is swaged so as to provide them with a slight concavity.

The applicant has yet proposed to solve this problem of warping of the bottom of culinary items formed from a swaged metal or light alloy sheet, in particular in documents FR 2 711 050 and FR 2 711 051, and EP 0 970 647 by embedding a plate in a portion of the sheet corresponding to the bottom of the culinary item, said plate having mechanical, thermal and physical properties different from that of such sheet.

In particular, the plate used in documents FR 2 711 050, FR 2 711 051 and EP 0 970 647 is made of steel or, preferably, of stainless steel. A copper plate can also be used.

However, if embedding such a plate proves to be satisfactory for culinary items formed from a metal or light alloy sheet, for example of aluminium or aluminium alloy, such an embedding turns out impossible in the case the sheet is made of anodised aluminium or anodised aluminium alloy.

Indeed, it is impossible to carry out the stamping of a plate into an anodised aluminium or anodised aluminium alloy sheet because of the hardness of the anodising layer.

It is also impossible to carry out an anodising step of the culinary item obtained after stamping a plate into an aluminium or aluminium alloy sheet, because the materials used for this type of plate, such as steel, stainless steel or otherwise copper, do not resist the subsequent anodising treatment.

On the other hand, it is known from documents US2005/205582 a culinary item formed from a swaged sheet having the final shape of the item and defining an inner surface intended to the baking of food and an outer surface intended to be disposed on the side of the heat source, the culinary item including a bottom and a lateral wall rising up from said bottom, wherein the outer surface of the bottom includes a plate centred on the bottom and covering at least a portion of the sheet. However, in US2005/205582, the plate is used to improve the thermal conductivity of the culinary item. Therefore, the plate is made of aluminium that has a good thermal conductivity. Yet, a plate of metal such as aluminium does not enable the warping of the bottom of this item occurring in the course of repeated heating and cooling cycles to be controlled.

Within this context, an object of the present invention is to provide a culinary item of the above-mentioned type in US2005/205582, for which an irreversible warping of the bottom in the course of repeated heating and cooling cycles is not observed.

For this, there is provided a culinary item that is formed from an aluminium or aluminium alloy sheet, wherein the outer surface at least of the lateral wall is made of anodised aluminium or anodised aluminium alloy and the inner surface of the culinary item is provided with a first anti-adhesive coating, and whose plate covering a portion of the outer surface of the bottom is made of a metal or of a material coated with a metal, a carbide or a nitride of a metal, said metal being selected so as to resist an anodising step.

By aluminium or aluminium alloy, it is meant in the sense of the present invention a metal material including aluminium, that meets the food contact ability requirements according to the 27 Aug. 1987 order.

Thanks to the presence of the embedded plate, the culinary item does not become warped under the effect of a very large number of repeated heating and cooling cycles.

Therefore, a culinary item is obtained which does not become warped over time while preserving its aesthetical properties provided by the areas of the outer surface that are made of anodised aluminium or anodised aluminium alloy.

The invention also relates to a method for producing a culinary item including a bottom and a lateral wall whose outer surface is made of anodised aluminium and whose inner surface is provided with an anti-adhesive coating.

It is already known from document GB 2 370 975 a method comprising the following steps:
shaping, by swaging, an aluminium or aluminium alloy sheet to provide it with the final shape of the culinary item and thus define the inner surface of the culinary item, intended to the baking of food, and the outer surface of the culinary item, intended to be disposed on the side of the heat source,
depositing, at least throughout the inner surface of the culinary item, at least one layer intended to form, after baking, a first anti-adhesive coating, and
anodising the culinary item, where the plate is made of a metal or a material coated with a metal, a carbide or a nitride of this metal, such metal being selected so as to resist this anodising step.

Such a method enables to produce culinary items having an outer surface of anodised aluminium or anodised aluminium alloy, whose appearance is visually soft to the touch. However, such items have a drawback that their bottom becomes budged after a number of repeated heating and cooling cycles, and that such warping is irreversible. Such items are then unusable on heat sources such as solid plates or ceramic hobs.

Within this context, an object of the present invention is therefore to provide a producing method of the above-mentioned type in GB 2 370 975, which enables the irreversible warping of the bottom of the item to be prevented on the course of repeated heating and cooling cycles.

For this, there is provided a method comprising a further step of applying by stamping on the outer surface of the bottom, a plate intended to cover at least a portion thereof, this stamping step being carried out before depositing the first anti-adhesive coating and anodising the culinary item.

The plate, easily stamped into the aluminium or aluminium alloy sheet, as well as the first anti-adhesive coating deposited throughout the inner surface of the culinary item, serve as masks protecting the areas of the sheet from anodising.

Indeed, there has been observed that the first anti-adhesive coating resists the last anodising step, and preserves anti-adhesiveness properties that are quite similar to those of an anti-adhesive coating that would have not been subjected to such an anodising step.

Accordingly, in the course of the last anodising step, only the portions of the aluminium or aluminium alloy sheet, that are not covered neither by the plate, nor by the first anti-adhesive coating, will be subjected to anodising treatment. Indeed, anodising, that is conventionally carried out in a sulphuric acid bath, does not affect neither the metal of the plate nor the metal covering said plate, nor the first anti-adhesive coating.

Advantageously, the method includes a further step carried out after the stamping step and the step of depositing the first anti-adhesive coating. According to this alternative, depositing at least one layer intended to form, after baking, a second anti-adhesive coating is carried out on all or part of the portion of the sheet not covered with the plate.

As previously, the second anti-adhesive coating, that resists the anodising step, behaviours acts as a mask during the last anodising step.

Indirectly, such an alternative of the method has a significant economical interest, because the costs related to the anodising step are proportional to the area of the sheet to be anodised.

Also, thanks to the application of a second anti-adhesive coating onto the outer surface of the bottom of the culinary item, the aluminium or aluminium alloy area that besides is not masked by the plate is decreased.

Accordingly, an outer face of the bottom fully coated by the plate only, or otherwise by a plate and by the second anti-adhesive coating can also be considered, and thus the anodising of the only outer surface of the lateral wall of the culinary item can be carried out.

It is also possible to cover all or part of the plate with the second anti-adhesive coating.

Further advantages and features of the present invention will result from the following description, given as non limiting examples and made in reference to the appended figures:

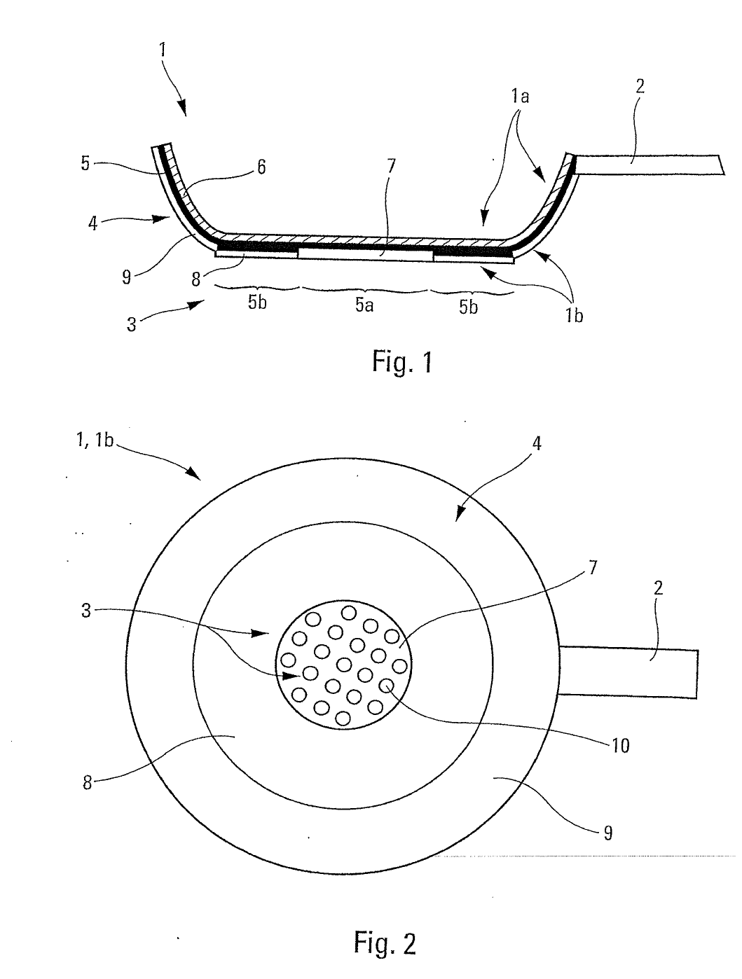

FIG. 1 shows a schematic cross-section view of a culinary item complying with the invention according to a first embodiment,

FIG. 2 shows a schematic bottom and plan view of the culinary item shown in FIG. 1, and

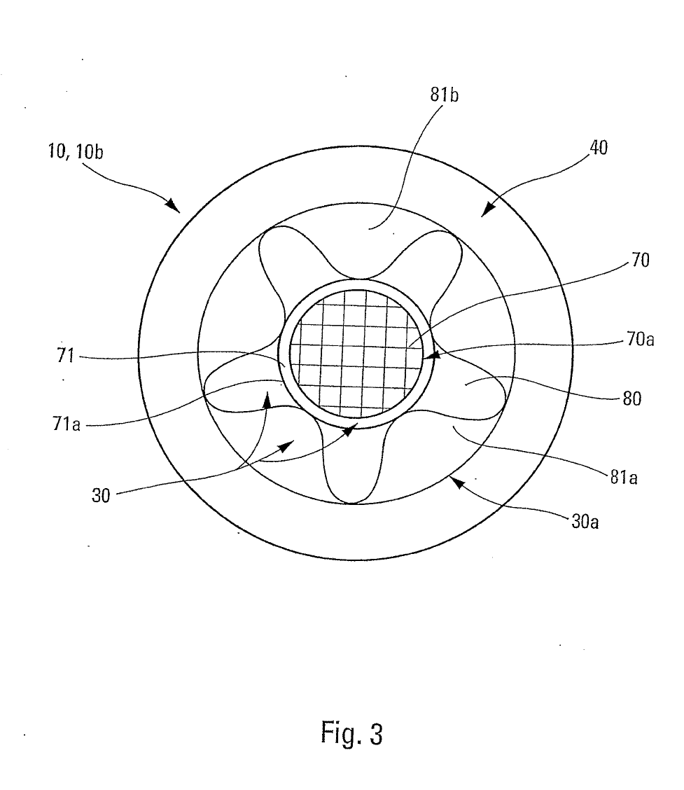

FIG. 3 shows a schematic bottom and plan view of the bottom of a culinary item according to a second embodiment.

Similar elements represented in FIGS. 1 and 2 are given identical reference numbers.

In FIGS. 1 and 2, there is shown, by way of exemplary culinary item, a frying pan 1.

The frying pan 1 includes a gripping handle 2, a bottom 3 and a lateral wall 4 rising up from said bottom 3.

The bottom 3 and the lateral wall 4 are made from a sheet 5 having a disc shape.

This sheet 5, that is made of aluminium or aluminium alloy, is swaged so as to have the final shape of the frying pan 1.

As exemplary aluminium alloys usable according to the present invention, in particular alloys known for their enamelling ability, for example 3003, 4006 and 4700 alloys can be cited. The preferred aluminium alloy is 3003 alloy.

The frying pan 1 includes an inner surface 1a intended to the baking of food and an outer surface 1b intended to be disposed on the side of the heat source, such as a coating plate or a burner.

The inner surface 1a of the frying pan 1 includes a first anti-adhesive coating 6.

The outer surface 1b of the bottom 3 includes a plate 7 centred onto the bottom 3 and covering at least a portion 5a of the sheet 5.

The plate 7 is made from a metal or a material coated by a metal.

In both cases, the metal of the plate 7 or the metal covering the material is selected such as to resist an anodising step, that is not to be damaged by the treatment in the sulphuric acid anodising bath.

Thus, the metal of the plate is more particularly selected from transition metals such as titanium, zirconium or niobium and is preferably, titanium.

The plate 7 can also be made of a material, this material being covered with a metal. In this case, the material, that forms the core of the plate 7, is selected from steel, stainless steel, ferritic or not, whereas the metal that covers said material is selected from transition metals such as titanium, zirconium, niobium, or otherwise by a carbide or nitride of a transition metal such as titanium, zirconium or niobium.

When a material having ferromagnetic properties is used, the frying pan 1 according to the invention has the advantage that it can be used with an induction heating means. A material suitable for this use is in particular AISI 430 stainless steel.

In the latter hypothesis, the plate 7 will be cut out and will extend preferably throughout the surface of the outer surface 1b of the bottom 3.

The plate 7 can possibly be comprised of several elements and thus not be a unit. It is preferably partially embedded into the sheet 5.

In the alternative illustrated in FIGS. 1 and 2, the portion 5b of the sheet 5 not covered with the plate 7 includes a second anti-adhesive coating 8 whereas the outer surface 1b of the lateral wall 4 includes an anodising layer 9.

The presence of the second anti-adhesive coating 8 is optional and it would be quite possible to consider a culinary item only including, at its outer surface 1b, the plate 7, totally or partially embedded. Thus, the lateral wall 4 and the surfaces of the outer surface 1b of the bottom 3 located outside the plate 7, and in particular at the portion 5a of the sheet 5, are made of anodised aluminium or anodised aluminium alloy.

As visibly represented in FIG. 2, the plate 7 includes particularly advantageously holes 10.

These holes 10 can be provided with a second anti-adhesive coating 8 or, on the contrary, left free and thus made of anodised aluminium or anodised aluminium alloy.

In the alternative illustrated in FIGS. 1 and 2, the outer surface 1b of the bottom 3 is wholly covered by the plate 7 and the second anti-adhesive coating 8, deposited at the portion 5b of the bottom 3 and into the holes 10.

However, it can quite be considered that the surfaces of the outer surface 1b of the bottom 3 that are not covered by the plate 7 and by the second anti-adhesive coating 8 are made of anodised aluminium or anodised aluminium alloy, as represented in FIG. 3 that will be detailed hereafter.

For the reasons previously mentioned in documents FR 2 711 050 and FR 2 711 051, the plate 7 covers between 5 and 30% of the total area of the bottom 3 whether it is intended for an culinary item 1 compatible or not with an induction baking mode. However, such a 30% value is not limited when a culinary item also having ferromagnetic properties is aimed at.

In a more particularly preferred alternative, the sheet 5 is swaged so as to provide a slight concavity to the bottom 3 of the culinary item 1.

However, in the latter hypothesis, when the culinary item 1 is disposed onto a cooking plate, the bearing surface of the bottom 3, generally annular and designated as “the seating diameter” is covered with the second anti-adhesive coating 8 to prevent any premature wear of the bottom 3 that would occur if this seating diameter would be in anodised aluminium or anodised aluminium alloy.

Such a culinary item in accordance with the invention, whose bottom area intended to contact the cooking plate is integrally coated with the second anti-adhesive coating 8, has thus two advantages, on the one hand, not to warp and, on the other hand, to resist wear and thus not to cause scratches or marks in particular on a ceramic hob.

In an advantageous version of the invention, the second anti-adhesive coating 8 can be an enamelled coating, a coating obtained from a composition including a thermostable resin resisting to at least 200° C., or otherwise a combination of these two types of coatings.

By way of an enamelled coating usable according to the present invention, an enamelled coating obtained from an enamelled frit composition including ferromagnetic compounds can be selected. Thus, a culinary item compatible with an induction heating mode can be obtained. By way of non limiting example, such a composition including an enamelled frit and ferromagnetic compounds is described in document FR 2 872 692 on behalf the applicant.

By way of an enamelled coating usable according to the invention, an enamelled coating can also be selected having a substantially uniform thickness whose average value is between 15 and 40 μm, preferably between 20 and 30 μm, with a deviation with respect to the thickness average value of at most 10%, wherein this enamelled coating includes 1.5 to 91 by weight with respect to the total weight of the enamelled coating of at least one melting element selected in the group consisting in lead oxide Pbo, bismuth oxide Bi₂O₃ and vanadium pentoxide V₂O₅.

Such an enamelled coating is able to resist a subsequent anodising treatment. Moreover, it has aesthetical qualities that make a finished enamelled coating useless.

Besides, if the melting element content in the enamelled coating is lower than 1.5% by weight with respect to the total weight of this coating, the latter is very porous and its integrity is not ensured. On the other hand, if the melting element content in the enamelled coating is higher than 9% by weight with respect to the total weight of this coating, the latter does not resist acid attacks.

If the thickness average value of the enamelled coating is lower than 15 μm (after baking), the enamelled coating is not tight enough and has an insufficient resistance to acid attacks, and thus to a sulphuric acid anodising.

Preferably, the melting element is vanadium pentoxide V₂O₅, in an amount of 2 to 7% by weight with respect to the total weight of the enamelled layer.

In a particularly advantageous version of the invention, the enamelled coating includes 4 to 6% by weight of vanadium pentoxide V₂O₅ with respect to the total weight of the coating. This vanadium content range in the enamelled coating will ensure a high resistance to acid attacks, and thus to a sulphuric acid anodising treatment.

Finally, by way of an enamelled coating usable according to the invention, a coating prepared from a composition including an enamelled frit, possibly completed with ferromagnetic compounds, and also including glass balls as described in the document FR 2 625 494 also on behalf of the applicant can also be selected.

As for the first anti-adhesive coating 6, it is obtained from a composition including a thermostable resin resisting to at least 200° C.

Such a thermostable resin resisting to at least 200° C., whether it is used for the composition of the first anti-adhesive coating 6 or the composition of the second anti-adhesive coating 8, conventionally includes a fluorocarboned resin, alone or blended with one or more other thermostable resins resisting to at least 200° C.

This fluorocarboned resin, whose hydrophobic properties are recognized, can be polytetrafluoroethylene (PTFE), tetrafluoroethylene-perfluoropropylvinylether copolymer (PFA) or tetrafluoroethylene-hexafluoropropylene copolymer (FEP) or a blend of these fluorocarboned resins.

The other thermostable resins resisting to at least 200° C. can be a polyamide imide (PAI), a polyethylene sulfone (PES), a polyphenylene sulphide (PPS), a polyetherketone (PEK), a polyetheretherketone (PEEK) or a silicone.

These thermostable resins have thus the particular advantage to resist an anodising step.

In the embodiment represented in FIG. 3, the bottom 30 of the culinary item 10 includes a plate 70 having the shape of a grid embedded into the aluminium or aluminium alloy sheet and centred on the bottom 30.

To make the culinary item 10 compatible with the induction heating mode, a plate provided with ferromagnetic properties can be used, either directly by the metal of the plate 70, such metal having besides to meet anodising resistance requirements, or indirectly by the material, in the case where the plate 70 is made of a material coated with a metal.

An annular groove 71 is provided at the periphery 70a of the grid 70.

At the portion between the periphery 71a of this annular groove 71 and the periphery 30a of the bottom 30, the bottom 30 includes a second anti-adhesive coating 80 forming a pattern and, outside the coated areas of this second anti-adhesive coating 80, surfaces 81a, 81b made of anodised aluminium or anodised aluminium alloy.

The outer surface 10b of the lateral wall 40 is integrally made of anodised aluminium or anodised aluminium alloy.

The method for producing a culinary item in accordance with the invention will now be detailed. This method includes the following consecutive steps, read in reference to FIGS. 1 to 3:
shaping, by swaging, an aluminium or aluminium alloy sheet 5 to provide it with the final shape of the culinary item 1, 10 and thus define the inner surface 1a of the culinary item, intended to the baking of food, and the outer surface of the culinary item 1b, 10b, intended to be disposed on the side of the heat source,
applying, by stamping, onto the outer surface 1b, 10b, of the bottom 3, 30, a plate 7, 70 intended to cover at least a portion of the sheet 5,
depositing, at least throughout the inner surface 1a of the culinary item 1, 10, at least one layer intended to form, after baking, a first anti-adhesive coating 6, and
anodising the culinary item 1, 10, where the plate 7, 70 is made of a metal or a material coated with a metal, said metal being selected so as to resist this anodising step.

As already indicated above, a transition metal such as titanium, zirconium or niobium for the metal of the plate 7, 70 and, possibly, steel or stainless steel, ferritic or not, as a material coated with said metal or with a carbide or nitride of such a metal are used.

In a more particularly advantageous version, the method according to the invention also includes, after the stamping step and before the depositing step of the first anti-adhesive coating 6, a step of making a second anti-adhesive coating 8, 80, on all or part of the portion of the sheet 5 not covered by the plate 7, 70.

In order to produce the second anti-adhesive coating 8, 80, a composition including a thermostable resin resisting to at least 200° C. can be deposited on all or part of the portion of the sheet 5 not covered by the plate 7, 70.

Such a thermostable resin resisting to at least 200° C. conventionally includes a fluorocarboned resin, alone or blended with one or more other thermostable resins resisting to at least 200° C.

This fluorocarboned resin, whose hydrophobic properties are recognized, can be polytetrafluoroethylene (PTFE), tetrafluoroethylene-perfluoropropylvinylether copolymer (PFA) or tetrafluoroethylene-hexafluoropropylene copolymer (FEP) or a blend of these fluorocarboned resins.

The other thermostable resins resisting to at least 200° C. can be a polyamide imide (PAI), a polyethylene sulfone (PES), a polyphenylene sulphide (PPS), a polyetherketone (PEK), or a polyetheretherketone (PEEK).

These thermostable resins have thus the particular advantage to resist an anodising treatment.

The present invention also relates to a method for producing a culinary item according to the invention.

Preferentially, this step of making a second anti-adhesive coating is a single enamelling step of all or part of the portion 5b of the sheet 5 not covered by the plate 7, 70, this enamelling step including the following consecutive steps:

i. preparing an anhydrous paste from a powdery enamelled frit that includes 0.82% to 6.75% by weight with respect to the total weight of the paste of at least one melting element selected from the group consisting in lead oxide Pbo, bismuth oxide Bi₂O₃ and vanadium pentoxide V₂O₅, said paste being formulated as a dispersion in a non aqueous medium;

ii. applying the anhydrous paste in at least one paste layer on all or part of a portion 5b of the sheet 5 not covered by the plate 7, 70;

iii. baking the paste layer to a temperature between 540° C. and 575° C., and preferably to a temperature of about 560° C., to form an enamelled coating that has, after baking, a substantially uniform thickness whose average value is between 15 and 40 μm with a deviation with respect to this thickness average value of at most 10%.

In the method of the invention, the single step of making an enamelled coating is carried out before the anodising step, which results in the aluminium area exposed to anodising being reduced. As the anodising costs are directly proportional to the aluminium area exposed in the anodising bath, the method of the invention has the advantage to be cheap.

The formulation of the enamelled frit as an anhydrous paste enables to obtain an enamelled coating having a higher resistance to a subsequent anodising treatment than that of an enamelled layer obtained from a slip (that is an enamelled frit dispersed in an aqueous medium), and accordingly carrying out an enamelling step after the anodising is not necessary without loss concerning the aesthetical qualities of the enamelling. Cancelling this enamelling step after anodising also enables the cost of such a method combining anodising and enamelling to be reduced.

This method has also the advantage to be compatible with any sort of aluminium or aluminium alloy. Preferably, the aluminium alloys used are 3003, 4006 and 4700 alloys. The preferred aluminium alloy is 3003 alloy.

Preferably, the anhydrous paste used in the method according to the invention includes 1.1 to 5.25%, and more preferably 2.2 to 4.5% by weight of vanadium pentoxide V₂O₅ with respect to the total weight of the paste.

Advantageously, the anhydrous paste includes 55 to 75% by weight of powdery enamelled frit with respect to the total weight of the paste. Indeed, if the paste contains more than 75% by weight of enamelled frit with respect to the total weight of the paste, this is too viscous and can not be spread out easily. On the other hand, if the paste contains less than 55% by weight of frit, the paste is far too fluid and needs to be deposited into several consecutive layers to result to an enamelled layer, after baking, having a thickness enough to resist acid attacks, which rises the global cost of the method accordingly.

Preferably, the anhydrous paste includes 65% by weight of powdery enamelled frit with respect to the total weight of the anhydrous paste. Such a paste has a sufficient fluidity to be spread out easily upon applying, as well as a sufficient consistency to enable a single layer to be applied to make an enamelled coating after baking having an average thickness to at least 15 μm.

If the enamelled frit has not a powdery shape, for example as flakes, a further step of dry milling of the enamelled frit will have to be provided in the producing method of the invention.

According to a particularly advantageous version of the invention, the enamelled frit includes:
SiO₂: 30 to 38%;
V₂O₅: 3 to 7%;
NaOH: 15 to 25%;
LiOH: 0.5 to 4%
KOH: 8 to 17%;
TiO₂: 18 to 25%;

the contents indicated being percentages by weight with respect to the weight of the frit.

In the anhydrous paste intended to produce the enamelled coating, the enamelled frit is dispersed into a non aqueous medium, that can be an oily medium or a solvent, preferably with a high boiling point (in particular higher than 150° C.) and preferably terpineol, white spirit (mineral original solvent, generally distilling between 130 to 200° C.) and mixtures thereof.

Besides the enamelled frit, the anhydrous paste according to the invention can also include additives such as pigments, fillers and/or opacifiers.

The anhydrous paste intended to produce the enamelled coating can be applied variously on the outer surface of the culinary item according to the invention, and in particular by spraying (gun spraying), with a curtain, by screen printing or otherwise by pad printing. Preferably, this application is carried out by screen printing or pad printing.

The viscosity of the anhydrous paste is adapted depending on the selected paste application technique. Thus, a paste having a viscosity of 2000 to 8000 Cp measured by a cone-plate type viscometer will preferably be applied by screen printing or by pad printing.

The anhydrous paste can be applied on the outer surface of the culinary item in a single layer or in several layers.

According to the first embodiment of the invention, the anhydrous paste is applied in a single layer so as to form an enamelled coating having, after baking, an average thickness between 15 and 30 μm.

According to a second embodiment of the invention, the anhydrous paste is applied in two layers, so as to produce an enamelled coating having, after baking, a thickness between 25 and 40 μm.

By way of exemplary application of the anhydrous paste into two layers, it can be considered for example to apply a first anhydrous paste layer by screen printing to yield a wet thickness of about 25 μm. This paste is then dried at 80° C. for 30 s, to yield a “biscuit” onto which is also applied by screen printing a second anhydrous paste layer of wet thickness around 25 microns. This layer is also dried. Then, both layers are stoved for 10 minutes at 560° C. to yield a vitreous enamel of 35 micron thickness.

It is self-evident that in the case where a first anti-adhesive coating 6 based on an organic resin and a second anti-adhesive coating 8, 80 of the enamel type are selected, the order in which the steps of depositing the different compositions is carried out will be imposed by the baking temperatures at which these compositions should be subjected for these first and second anti-adhesive coatings 6, 8, 80 to be obtained.

The last anodising step is conventionally carried out by dipping the culinary item into a sulphuric acid bath, alone or in a mixture with oxalic acid, and with a temperature of the acid bath between −5° C. and 25° C. The D.C. voltage applied to the item can range from 10 to 100 V.

Preferably, this anodising is said to be a “hard” anodising, carried out in a sulphuric acid bath whose temperature is −5° C.

Anodising is generally completed by a hydrothermal sealing step, whose principle consists in converting alumina Al₂O₃ formed during anodising into monohydrate alumina. This results in the porosity of the anodising layer being reduced. This treatment is carried out by dipping into a water bath whose minimal temperature is 90° C. and whose pH value is between 5.5 and 6.5.

Various alternatives can be made to the present invention, without departing from the scope of this invention.

1. A culinary item (1, 10) formed from a swaged sheet (5) having the final shape of the item (1, 10) and defining an inner surface (1a) intended to the baking of food and an outer surface (1b, 10b) intended to be disposed towards the heat source, said culinary item (1, 10) including a bottom (3, 30) and a lateral wall (4, 40) rising from said bottom (3, 30), the outer surface (1b, 10b) of the bottom (3, 30) including a plate (7, 70) centred on the bottom (3, 30) and covering at least a portion (5a) of the sheet (5), characterized in that the sheet (5) is made of aluminium or aluminium alloy and the plate (7, 70) is made of a metal or a material coated with a metal, or a carbide or a nitride of a metal, said metal being selected so as to resist an anodising step, and in that the outer surface (1b, 10b) at least of the lateral wall (4, 40) is made of anodised aluminium or anodised aluminium alloy and in that the inner surface (1a) of the culinary item (1, 10) is provided with a first anti-adhesive coating (6).

2. A culinary item (1, 10) according to claim 1, characterized in that the portion (5b) of the sheet (5) forming the bottom (3, 30) and not covered with the plate (7, 70) includes a second anti-adhesive coating (8, 80).

3. A culinary item (1, 10) according to claim 1, characterized in that the plate (7, 70), possibly comprised of several elements, is partially embedded into the sheet (5).

4. A culinary item (1, 10) according to claim 1, characterized in that the plate (7, 70), that can include holes (10), covers between 5 and 30% of the total area of the bottom (3, 30).

5. A culinary item (1, 10) according to claim 1, characterized in that the metal of the plate (7, 70) is selected from transition metals such as titanium, zirconium or niobium, the material optionally forming the core thereof that is then covered with the said metal or a carbide or nitride of this metal, being selected from steel, stainless steel, ferritic or not.

6. A culinary item (1, 10) according to claim 2, characterized in that the bottom (3, 30) of the culinary item (1, 10) being slightly concave, the area of the bottom (3, 30) intended to contact the cooking plate is integrally coated with the second anti-adhesive coating (8, 80).

7. A culinary item (1, 10) according to claim 2, characterized in that the second anti-adhesive coating (8, 80) is an enamelled coating and/or a coating obtained from a composition including a thermostable resin resisting to at least 200° C.

8. A culinary item (1, 10) according to claim 1, characterized in that the first anti-adhesive coating (6) is obtained from a composition including a thermostable resin resisting to at least 200° C.

9. A culinary item (1, 10) according to claim 7, characterized in that the thermostable resin resisting to at least 200° C. is a silicone resin or a fluorocarboned resin such as PTFE.

10. A culinary item (1) according to claim 2, characterized in that the outer surface (1b) of the bottom (3) is totally covered with the plate (7) and the second anti-adhesive coating (8).

11. A culinary item (10) according to claim 2, characterized in that the surfaces (81a, 81b) of the outer surface (10b) of the bottom (30) that are not covered with the plate (70) and with the second anti-adhesive coating (80), are made of anodised aluminium or anodised aluminium alloy.

12. Method for producing a culinary item (1, 10) including a bottom (3, 30) and a lateral wall (4, 40) rising up from the bottom (3, 30), said method comprising the following steps:
shaping, by swaging, an aluminium or aluminium alloy sheet (5) to provide it with the final shape of the culinary item (1, 10) and thus define the inner surface (1a) of the culinary item (1, 10), intended to the baking of food, and the outer surface (1b, 10b) of the culinary item (1, 10), intended to be disposed on the side of the heat source;
depositing, at least throughout the inner surface (1a) of the culinary item (1, 10), at least one layer intended to form, after baking, a first anti-adhesive coating (6); and then
anodising the culinary item (1, 10), where the plate (7, 70) is made of a metal or a material coated with a metal, a carbide or a nitride of this metal, such metal being selected so as to resist this anodising step;
characterized in that the method further includes a step of applying, by stamping, onto the outer surface (1b, 10b) of the bottom (3, 30), a plate (7, 70) intended to cover at least a portion (5a) of the sheet (5), said stamping step being carried out before the steps of depositing at least one layer intended to form after the baking a first anti-adhesive coating, and then of anodising the culinary item.

13. Method according to claim 12, characterized in that, after the stamping step and before the step of depositing the first anti-adhesive coating (6), depositing of at least one layer intended to form, after baking, a second anti-adhesive coating (8, 80) is further carried out, on all or part of the portion (5b) of the sheet (5) not covered with the plate (7, 70).

14. Method according to claim 12, characterized in that a transition metal such as titanium, zirconium or niobium for the metal of the plate (7, 70) and, optionally, steel or stainless steel, ferritic or not, as the material coated with the said metal or a carbide or nitride of the said metal are used.

15. Method according to claim 12, characterized in that a composition including a thermostable resin resisting to at least 200° C. to form the first anti-adhesive coating (6) is used.

16. Method according to claim 13, characterized in that a composition including an enamelled frit and/or a thermostable resin resisting to at least 200° C. to form the second anti-adhesive coating (8, 80) is used.

17. Method according to claim 15, characterized in that the thermostable resin resisting to at least 200° C. is a silicone resin or a fluorocarboned resin such as PTFE.

18. A culinary item (1, 10) according to claim 8, characterized in that the thermostable resin resisting to at least 200° C. is a silicone resin or a fluorocarboned resin such as PTFE.

19. Method according to claim 16, characterized in that the thermostable resin resisting to at least 200° C. is a silicone resin or a fluorocarboned resin such as PTFE.
